(19) United States
(12) Patent Application Publication
(10) Pub. No.: US 2019/0072648 A1
(43) Pub. Date: Mar. 7, 2019

(54) IMAGING CONTROL APPARATUS, IMAGING CONTROL METHOD, IMAGING CONTROL PROGRAM, AND RECORDING MEDIUM HAVING IMAGING CONTROL PROGRAM RECORDED THEREON

(71) Applicant: PANASONIC INTELLECTUAL PROPERTY MANAGEMENT CO., LTD., Osaka (JP)

(72) Inventors: Hiroshi IWAI, Osaka (JP); Tetsuro OKUYAMA, Osaka (JP); Osamu SHIBATA, Kanagawa (JP); Takehiro TANAKA, Osaka (JP)

(73) Assignee: PANASONIC INTELLECTUAL PROPERTY MANAGEMENT CO., LTD., Osaka (JP)

(21) Appl. No.: 16/119,321

(22) Filed: Aug. 31, 2018

(30) Foreign Application Priority Data
Sep. 1, 2017 (JP) 2017-168597
Sep. 1, 2017 (JP) 2017-168600

(51) Int. Cl. G01S 7/486; G01S 17/89; G01S 17/10

(52) U.S. Cl. CPC G01S 7/486; G01S 17/10; G01S 17/89

(57) ABSTRACT

There is provided an imaging control apparatus which can improve distance measurement precision of a time of flight distance measurement method. The imaging control apparatus includes: a clustering processor which clusters a region from which a feature point is extracted based on an infrared image or a distance image obtained by an imaging apparatus; and a distance measurer which derives a distance to a target corresponding to the region by a time of flight distance measurement method based on information of each pixel in the region clustered by the clustering processor.

### TECHNICAL FIELD

The present disclosure relates to an imaging control apparatus, an imaging control method, an imaging control program and a recording medium having the imaging control program recorded thereon.

### BACKGROUND ART

Conventionally, there is a known surrounding monitoring system which causes a light source to emit invisible light (infrared light or near infrared light), causes a distance image sensor to receive the invisible light (referred to as “return light” below in some cases) which has been reflected by a surrounding target and returned, and calculates a distance to a target by a time of flight distance measurement method.

### CITATION LIST

### Patent Literature

PTL 1
Japanese Patent Application Laid-Open No. 2000-147370
PTL 2
Japanese Patent Application Laid-Open No. 2012-114636

### SUMMARY OF INVENTION

### Technical Problem

However, the conventional surrounding monitoring system has a problem that, when a light intensity of invisible light which has been reflected by the surrounding target and returned is low, distance measurement precision lowers.

An object of the present disclosure is to improve distance measurement precision of a time of flight distance measurement method.

### Solution to Problem

An aspect of the present disclosure provides an imaging control apparatus including: a clustering processor which clusters a region from which a feature point is extracted based on an infrared image or a distance image obtained by an imaging apparatus; and a distance measurer which derives a distance to a target corresponding to the region by a time of flight distance measurement method based on information of each pixel in the region clustered by the clustering processor. In addition, one aspect of the present disclosure may be one of an imaging control method, an imaging control program and a non-transitory and tangible recording medium having the imaging control program recorded thereon.

### Advantageous Effects of Invention

An object of the present disclosure is to improve distance measurement precision of a time of flight distance measurement method.

### BRIEF DESCRIPTION OF DRAWINGS

FIG. 1 is a view showing a vertical field of view of a surrounding monitoring system on which an imaging control apparatus according to an embodiment of the present disclosure is mounted;

FIG. 2 is a view showing a horizontal field of view of the surrounding monitoring system on which the imaging control apparatus according to the embodiment of the present disclosure is mounted;

FIG. 3 is a block diagram showing a configuration of the surrounding monitoring system on which the imaging control apparatus according to Embodiment 1 of the present disclosure is mounted;

FIG. 4 is a schematic view showing an outline of a time of flight distance measurement method;

FIG. 5 is a schematic view showing a state of emission light and return light;

FIG. 6 is a flowchart showing an example of processing performed by a clustering processor and a distance measurer;

FIG. 7A is a schematic view showing a visible image of a black vehicle;

FIG. 7B is a schematic view showing an infrared image of the black vehicle;

FIG. 8A is a schematic view showing a visible image of a parking space at which wheel stoppers are installed;

FIG. 8B is a schematic view showing an infrared image of the parking space at which the wheel stoppers are installed;

FIG. 9 is a flowchart showing another example of processing performed by the clustering processor and the distance measurer;

FIG. 10 is a block diagram showing a configuration of a surrounding monitoring system on which an imaging control apparatus according to Embodiment 2 of the present disclosure is mounted;

FIG. 11 is a flowchart showing an example of height estimation processing;

FIG. 12 is a flowchart showing an example of distance measurement processing;

FIG. 13 is a flowchart showing another example of distance measurement processing;

FIG. 14A is a schematic view showing a visible image of a parking space at which wheel stoppers are installed;

FIG. 14B is a schematic view showing an infrared image of the parking space at which the wheel stoppers are installed;

FIG. 14C is a schematic view showing subclustered subcluster regions;

FIG. 15A is a schematic view showing an example of an installation place of an imaging apparatus;

FIG. 15B is a schematic view showing another example of the installation place of the imaging apparatus; and

FIG. 15C is a schematic view showing still another example of the installation place of the imaging apparatus.

### DESCRIPTION OF EMBODIMENTS

Surrounding monitoring systems 1 and 1A on which imaging control apparatuses 100 and 100A according to one embodiment of the present disclosure are mounted will be described in detail below with reference to the drawings. In this regard, the embodiments described below are examples, and the present disclosure is not limited by these embodiments.

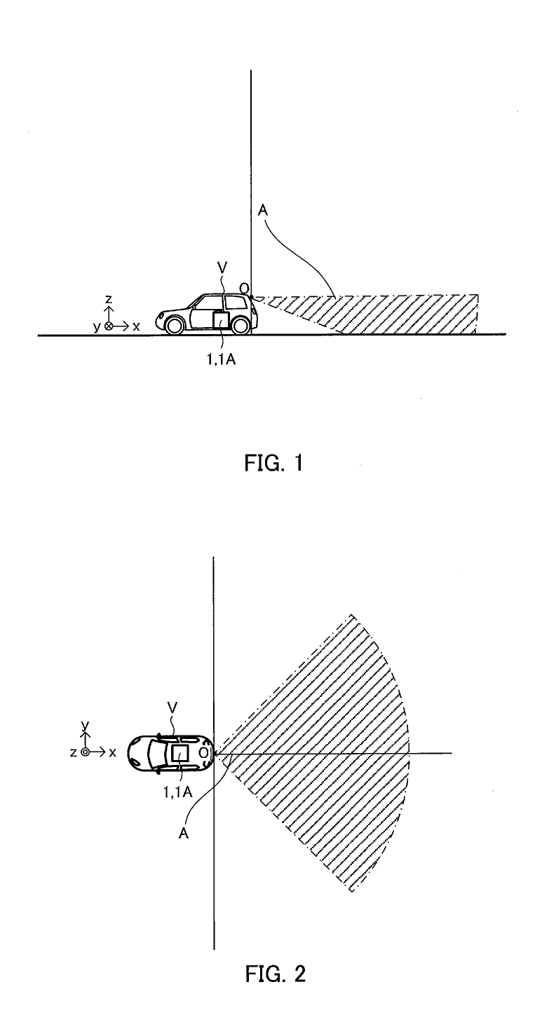

FIGS. 1 and 2 show an x axis, a y axis and a z axis perpendicular to each other. In the present disclosure, the x axis indicates a direction (referred to as “forward and backward directions x” below) traveling from a front portion to a rear portion of vehicle V. The y axis indicates a direction (referred to as “left and right directions y” below) traveling from a left side to a right side of vehicle V. The z axis indicates a direction (referred to as “upper and lower directions z” below) traveling from a lower portion to an upper portion of vehicle V. Furthermore, in the present disclosure, an xy plane is a road surface, and a zx plane is a vertical center plane of vehicle V for ease of description. Furthermore, the x axis is a vertical center line in a plan view from upper and lower directions z.

As shown in FIGS. 1 and 2, surrounding monitoring systems 1 and 1A are mounted on vehicle V. Hereinafter, it is stated that surrounding monitoring system 1 and 1A monitor a rear side of vehicle V. However, surrounding monitoring system 1 and 1A may monitor sides (lateral sides, a front side or all surrounding directions) other than the rear side of vehicle V.

### Embodiment 1

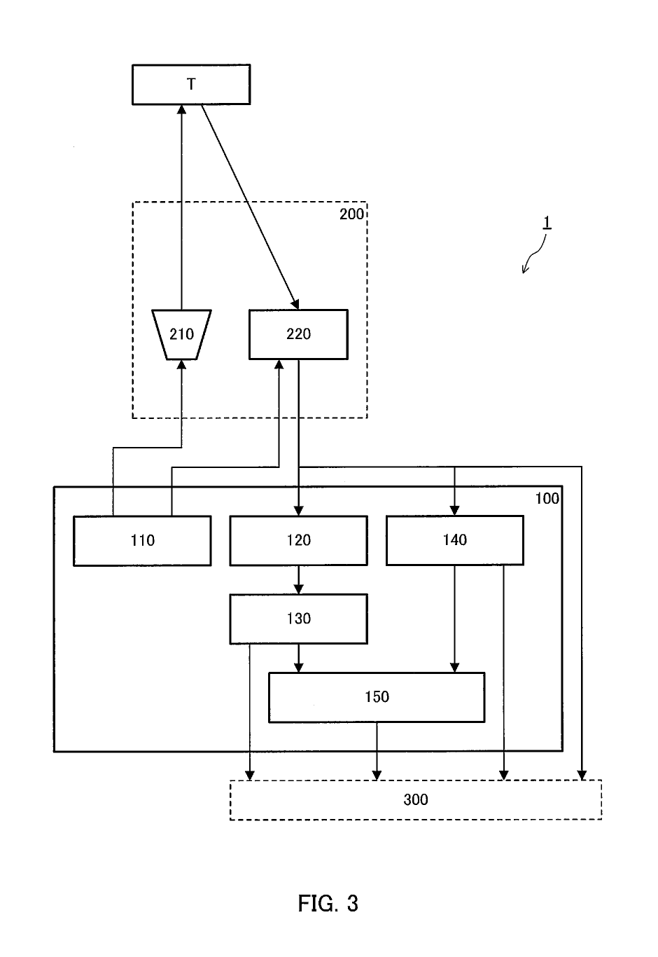

As shown in FIG. 3, surrounding monitoring system 1 includes imaging apparatus 200 which is formed by integrating light source 210 and image sensor 220, and imaging control apparatus 100.

As shown in FIG. 1, imaging apparatus 200 is attached on a back surface of vehicle V and to place O apart from a road surface.

Light source 210 is attached so as to be able to emit pulsed invisible light (e.g., infrared light or near infrared light) to an imaging range.

Image sensor 220 is, for example, a complementary metal oxide semiconductor (CMOS) image sensor, and is attached to substantially the same place as light source 210 such that optical axis A of Image sensor 220 extends to the substantially rear side of vehicle V.

Imaging control apparatus 100 is, for example, an electronic control unit (ECU), and includes an input terminal, an output terminal, a processor, a program memory and a main memory mounted on a control substrate to control monitoring of the rear side of vehicle V.

The processor executes programs stored in the program memory by using the main memory to process various signals received via the input terminal, and transmit various control signals to light source 210 and image sensor 220 via the output terminal.

When the processor executes the program, imaging control apparatus 100 functions as controller 110, clustering processor 120, distance measurer 130, edge extractor 140 and target extractor 150 as shown in FIG. 3.

Controller 110 outputs a control signal to light source 210 to control some conditions (more specifically, a pulse width, a pulse amplitude, a pulse interval and the number of pulses) of emission light from light source 210.

Furthermore, controller 110 outputs a control signal to a peripheral circuit included in image sensor 220 to control some receiving conditions (more specifically, an exposure time, an exposure timing and the number of times of exposure) of return light of image sensor 220.

According to the above exposure control, image sensor 220 outputs a visible image signal, an infrared image signal and a depth image signal related to the imaging range to imaging control apparatus 100 at a predetermined cycle (predetermined frame rate).

Furthermore, in the present embodiment, image sensor 220 performs so-called lattice transformation of adding information of a plurality of neighboring pixels, and generating image information. In this regard, according to the present disclosure, it is not indispensable to add the information of a plurality of neighboring pixels and generate the image information.

Clustering processor 120 clusters a pixel corresponding to target T based on the infrared image signal or the depth image signal outputted from image sensor 220. Processing performed by clustering processor 120 will be described below.

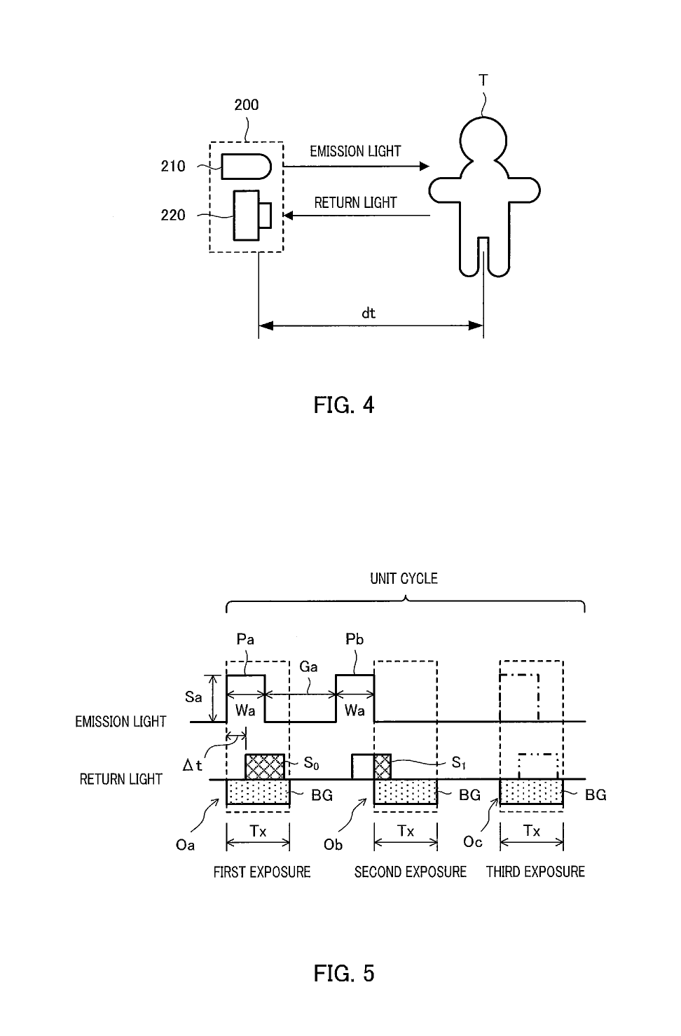

Distance measurer 130 derives distance dt (see FIG. 4) to target T in the imaging range by a time of flight distance measurement method (referred to as a “Time of Flight (TOF)” method below) based on the depth image signal outputted from image sensor 220. Processing performed by distance measurer 130 will be described below.

Hereinafter, distance measurement according to the TOF method will be briefly described. Measurement of the distance to target T by the TOF method is realized by a combination of light source 210, image sensor 220 and distance measurer 130. Distance measurer 130 derives distance dt to target T shown in FIG. 4 based on a time difference or a phase difference between an emission timing of the emission light from light source 210 and a light reception timing of the return light of image sensor 220.

edge extractor 140 receives a visible image signal from image sensor 220 per unit cycle, for example, extracts a target edge based on the received visible image signal, and generates edge information which defines the extracted edge.

Target extractor 150 obtains distance image information from distance measurer 130 per unit cycle, for example, and obtains the edge information from edge extractor 140.

Target extractor 150 extracts a portion which represents the target existing in the imaging range as first target information from the received distance image information. Target extractor 150 further extracts a portion which represents the target existing in the imaging range as second target information by, for example, optical flow estimation from the edge information obtained this time from edge extractor 140 and previously obtained edge information.

Target extractor 150 assigns a target identifier (ID) which makes it possible to uniquely identify the detected target, to the extracted first target information and/or second target information.

Surrounding monitoring system 1 outputs a combination of the above first target information and the target ID, a combination of the second target information and the target ID, the infrared image signal, the depth image signal and the visible image signal. This information is transmitted to, for example, advanced driver assistance system (ADAS) ECU 300. ADAS ECU 300 automatically drives vehicle V by using these pieces of information.

Furthermore, controller 110 may generate image information which needs to be displayed on, for example, an unillustrated display based on the combination of the above first target information and the target ID, the combination of the second target information and the target ID, the infrared image signal, the depth image signal and the visible image signal.

Next, an example of distance measurement according to the TOF method will be described. As shown in FIG. 5, the emission light from light source 210 includes a pair of first pulse Pa and second pulse Pb in a unit cycle. A pulse interval between these pulses (i.e., a time from a rising edge of first pulse Pa to a rising edge of second pulse Pb) is Ga. Furthermore, pulse amplitudes of these pulses are equally Sa, and these pulse widths are equally Wa.

Image sensor 220 is controlled by controller 110 to perform exposure at a timing based on emission timings of first pulse Pa and second pulse Pb. More specifically, as shown in FIG. 5, image sensor 220 performs first exposure, second exposure and third exposure on invisible light which is the emission light from light source 210 and which has been reflected by target T in the imaging range and returned.

The first exposure starts at the same time as a rise of first pulse Pa, and ends after exposure time Tx set in advance in relation to the emission light from light source 210. This first exposure intends to receive return light components of first pulse Pa.

Output Oa of image sensor 220 resulting from the first exposure includes return light component S₀ to which an oblique lattice hatching is applied, and background component BG to which a dot hatching is applied. The amplitude of return light component S₀ is smaller than the amplitude of first pulse Pa.

A time difference between the rising edges of first pulse Pa and return light component S₀ is Δt. Δt represents a time taken by invisible light to travel back and forth over distance dt between imaging apparatus 200 and target T.

The second exposure starts at the same time as a fall of second pulse Pb, and ends after exposure time Tx. This second exposure intends to receive return light components of second pulse Pb.

Output Ob of image sensor 220 resulting from the second exposure includes partial return light component S₁ (see a diagonal lattice hatching portion) which is not the overall return light component, and background component BG to which a dot hatching is applied.

In addition, above component S₁ to be observed is generally given by following Equation 1.

S₁=S₀×(Δt/Wa) (1)

The third exposure starts at a timing which does not include the return light component of first pulse Pa and second pulse Pb, and ends after exposure time Tx. This third exposure intends to receive only background component BG which is an invisible light component irrelevant to the return light component.

Output Oc of image sensor 220 resulting from the third exposure includes only background component BG to which a dot hatching is applied.

Distance dt from image sensor 220 to target T can be derived based on the above relationship between the emission light and the return light according to following Equations 2 to 4.

S₀=Oa−BG (2)

S₁=Ob−BG (3)

dt=c×(Δt/2)={(c×Wa)/2}×(Δt/Wa)={(c×Wa)/2}×(S₁/S₀) (4)

In this regard, c represents a light velocity.

By the way, when distance dt is derived by the above method, if the light intensity of the return light with respect to each of first pulse Pa and second pulse Pb is low, it is likely that an signal to noise (SN) ratio of output Oa and output Ob of image sensor 220 becomes small, and precision of derived distance dt lowers.

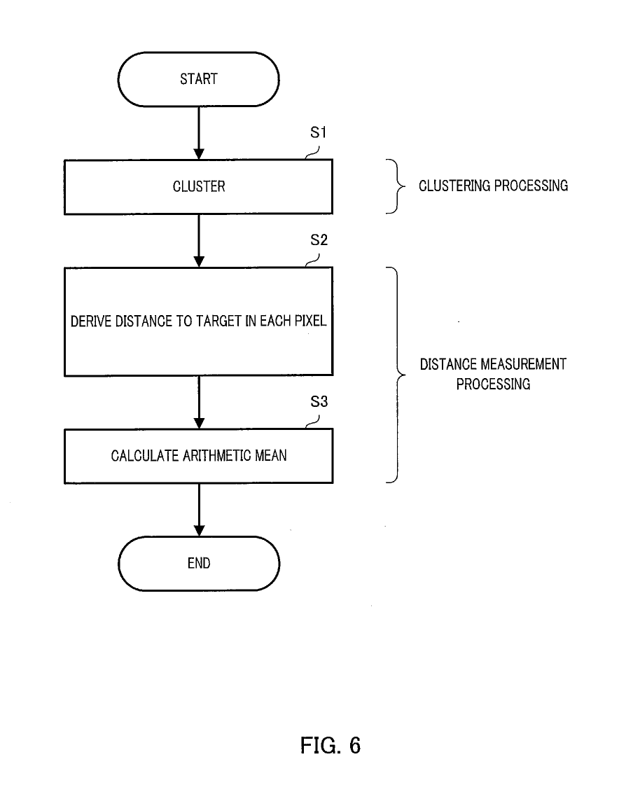

Hence, in the present embodiment, clustering processor 120 performs clustering processing on a pixel corresponding to target T prior to distance measurement processing of distance measurer 130. An example of the processing performed by clustering processor 120 and distance measurer 130 will be described in detail with reference to a flowchart in FIG. 6.

First, in step S1, clustering processor 120 extracts feature points and clusters a plurality of pixels based on the infrared image signal or the depth image signal outputted from image sensor 220.

When, for example, the infrared image signal is used, clustering processor 120 extracts as feature points a plurality of pixels whose luminance in the imaging range is higher than a predetermined value and is within a predetermined range, and clusters the plurality of pixels.

Furthermore, when, for example, the depth image signal is used, clustering processor 120 extracts as feature points a plurality of pixels whose distance information in the imaging range is within a predetermined range, and clusters the plurality of pixels. In addition, clustering is performed not only on neighboring pixels but also on dispersed pixels.

In subsequent step S2, distance measurer 130 derives a distance to a target in each pixel in each region clustered by clustering processor 120 by using the depth image signal. A method for deriving the distance to the target in each pixel is the same as the method described above.

In subsequent step S3, distance measurer 130 calculates an arithmetic mean of the distances to the target in the respective pixels in the clustered regions, and calculates a representative distance to the clustered region. Furthermore, the calculated representative distance is outputted as the distance to the target.

By so doing, it is possible to calculate a distance to a target by using information of distances to the target in the plurality of pixels, and improve distance measurement precision.

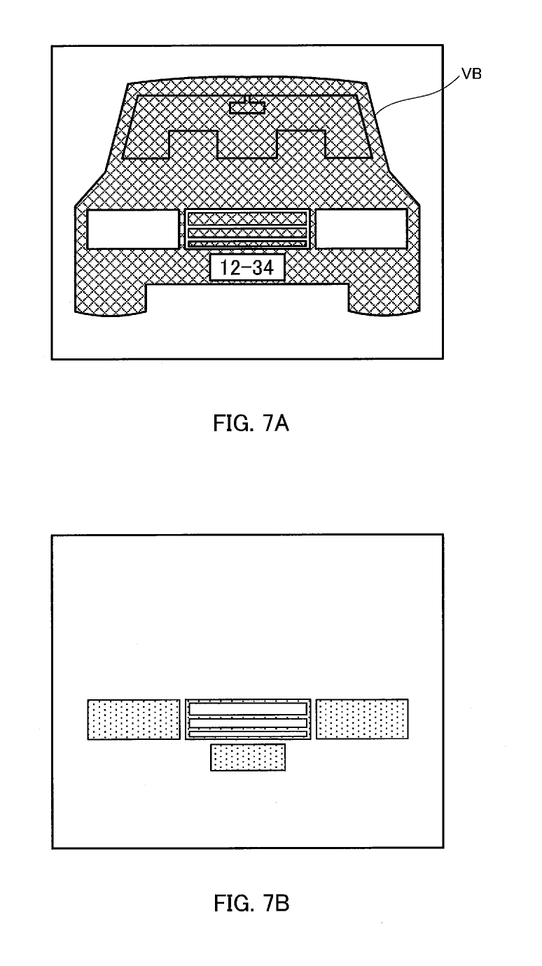

Next, a first specific example of distance measurement of a target performed by the surrounding monitoring system on which the imaging control apparatus according to the present embodiment is mounted will be described with reference to FIGS. 7A and 7B.

In the first specific example, a distance between subject vehicle VM and black vehicle VB driving at the back of subject vehicle VM is derived. FIG. 7A shows a visible image of vehicle VB included in an imaging range. Furthermore, FIG. 7B shows an infrared image of vehicle VB. In addition, the infrared image shown in FIG. 7B is obtained by using the above lattice transformation.

As shown in FIG. 7B, the infrared image shows pieces of high luminance of head lights, a number plate and a front grill of vehicle VB, and pieces of low luminance of other portions such as a black body and tires. In addition, FIG. 7B shows only the head lights, the number plate and the front grill of the high luminance for ease of understanding.

Furthermore, positions in the forward and backward directions of the head lights, the number plate and the front grill are within the predetermined range. The pieces of luminance of the head lights, the number plate and the front grill in the infrared image are within the predetermined range. Therefore, imaging control apparatus 100 (more specifically, clustering processor 120) clusters the head lights, the number plate and the front grill.

Subsequently, distance measurer 130 derives a distance to a target in each pixel in clustered regions (i.e., regions corresponding to the head lights, the number plate and front grills) by the TOF method.

Furthermore, distance measurer 130 adds distances to the target in the respective pixels of the clustered regions, and divides an addition result by the number of pixels in the clustered regions. By so doing, an average value of the distances to the target in the clustered regions is calculated.

Distance measurer 130 outputs the average value of the distances to the target in the clustered regions calculated in this way as a distance from subject vehicle VM to black vehicle VB.

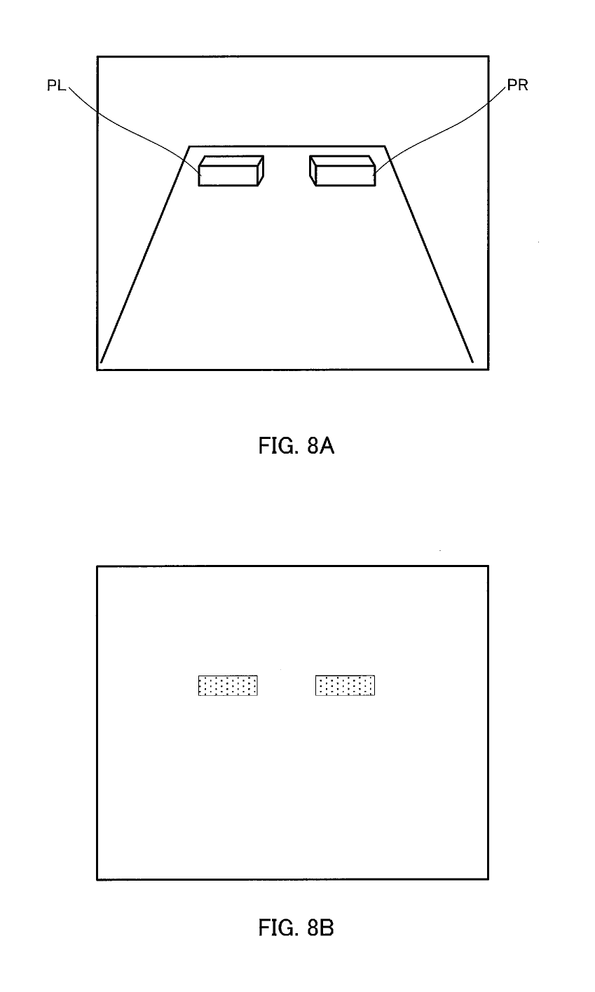

A second specific example of distance measurement of a target performed by the surrounding monitoring system on which the imaging control apparatus according to the present embodiment is mounted will be described with reference to FIGS. 8A and 8B.

In the second specific example, when subject vehicle VM is parked by driving backward in a parking space provided with wheel stoppers PR and PL, a distance from subject vehicle VM to wheel stoppers PR and PL is derived. FIG. 8A shows a visible image of wheel stoppers PR and PL included in an imaging range. Furthermore, FIG. 8B shows an infrared image of wheel stoppers PR and PL. In addition, the infrared image shown in FIG. 8B is obtained by using the above lattice transformation.

As shown in FIG. 8B, the infrared image shows pieces of high luminance of front end surfaces of wheel stoppers PR and PL facing image sensor 220. On the other hand, other portions such as a road surface forming a large angle with respect to imaging apparatus 200 and having a low reflectance have low luminance. In addition, FIG. 8B shows only the front end surfaces of wheel stoppers PR and PL of high luminance for ease of understanding.

Positions in the forward and backward directions of the front end surfaces of wheel stoppers PR and PL are within the predetermined range. Therefore, the pieces of luminance of the front end surfaces of wheel stoppers PR and PL in the infrared image are within the predetermined range. Hence, imaging control apparatus 100 (more specifically, clustering processor 120) clusters the front end surfaces of wheel stoppers PR and PL.

Subsequently, distance measurer 130 derives the distance to the target in each pixel of the clustered regions (i.e., the regions corresponding to the front end surfaces of wheel stoppers PR and PL) by the TOF method.

Furthermore, distance measurer 130 adds distances to the target in the respect pixels of the clustered regions, and divides an addition result by the number of pixels in the clustered regions. By so doing, an average value of the distances to the target in the clustered regions is calculated.

Distance measurer 130 outputs the average value of the distances to the target in the clustered regions derived in this way as a distance from subject vehicle VM to wheel stoppers PR and PL.

As described above, according to Embodiment 1, feature points are extracted based on an infrared image or a distance image, and regions from which the feature points are extracted are clustered. Furthermore, distances to a target in respective pixels in the clustered regions are derived by the TOF method, and an arithmetic mean of the derived distances is calculated to calculate the distance to the target.

Consequently, it is possible to calculate a distance to a target by using information of distances to the target in a plurality of pixels, and improve distance measurement precision.

In Embodiment 1, after clustering processing, the arithmetic mean of the distances to the target in the respective pixels in the clustered regions is calculated to calculate the distance to the target. By contrast with this, the return light components of the clustered regions may be integrated to measure the distance by using the integrated return light components.

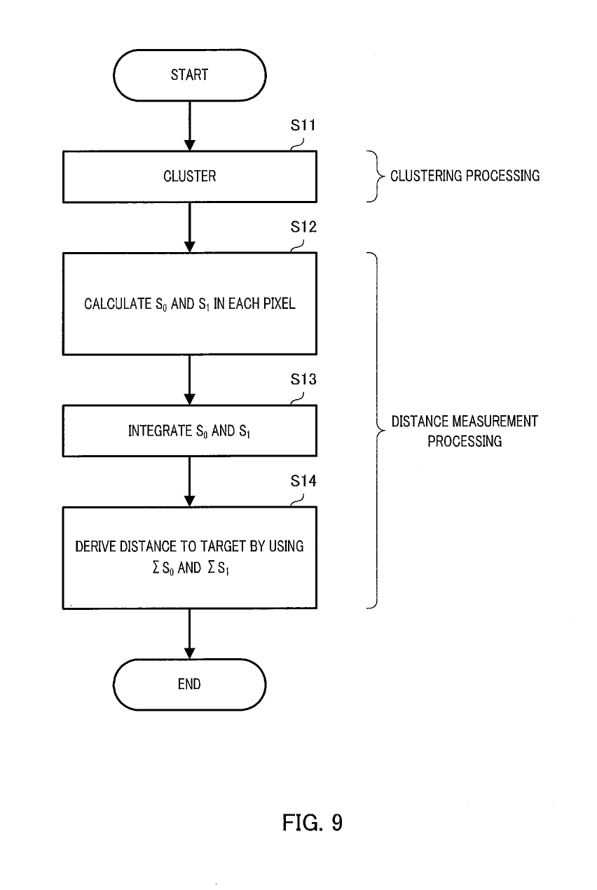

Another example of the processing performed by clustering processor 120 and distance measurer 130 will be described in detail with reference to a flowchart in FIG. 9.

First, in step S11, clustering processor 120 extracts feature points and clusters a plurality of pixels based on the infrared image signal or the depth image signal outputted from image sensor 220. A specific clustering method is the same as that of the above embodiment.

In subsequent step S12, distance measurer 130 calculates return light components S₀ and S₁ in each pixel in each region clustered by using the depth image signal according to above Equations 2 and 3.

In subsequent step S13, distance measurer 130 integrates return light components S₀ and S₁ of each pixel in each clustered region, and obtains integration values ΣS₀ and ΣS₁ of the return light components.

In subsequent step S14, distance measurer 130 derives a representative distance to the clustered region, i.e., distance dt to the target by using following Equation 5.

dt={c×Wa}/2}×(ΣS₁/ΣS₀) (5)

By so doing, it is possible to derive distance dt to a target by using the integration values of the return light components in the plurality of pixels, and improve distance measurement precision.

As described above, according to a modified example, feature points are extracted based on an infrared image or a distance image, and regions from which the feature points are extracted are clustered. Furthermore, the return light components in each pixel of each clustered region are integrated to derive the distance to the target by the TOF method by using the integration values of the return light components.

Consequently, it is possible to derive distance dt to a target by using the integration values of the return light components in the plurality of pixels, and improve distance measurement precision.

In addition, in the present disclosure, it is not indispensable for the image sensor to output all of a visible image signal, an infrared image signal and a depth image signal. When clustering is performed based on the depth image signal, the infrared image signal may not be outputted. Furthermore, when, for example, edge information is not necessary, the visible image signal may not be outputted.

### Embodiment 2

Conventionally, there is a known light detection and ranging (LiDAR) system as a surrounding monitoring system which causes a light source to emit laser light, causes a detector to receive the laser light which has been reflected by a surrounding target and returned, and monitors the surroundings.

However, the LiDAR system has a low spatial resolution in a height direction, and has difficulty in estimating the height of the target. Embodiment 2 provides an imaging control apparatus which employs the following configuration to precisely estimate the height of the target.

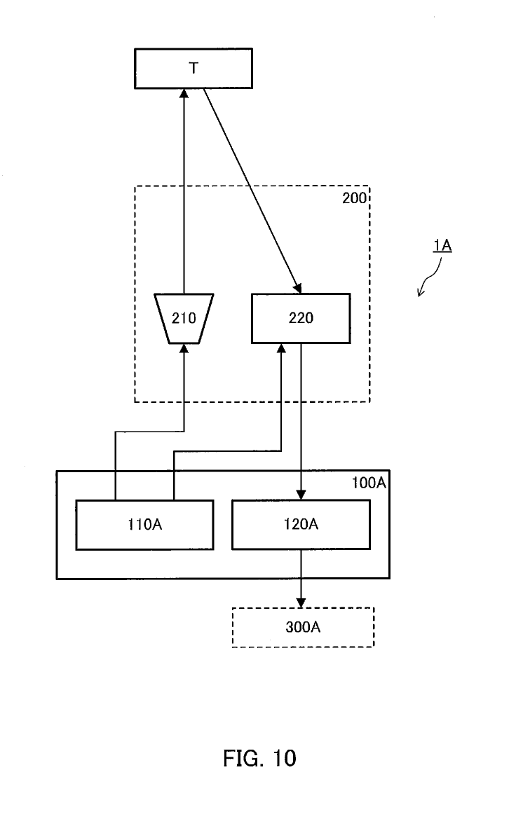

As shown in FIG. 10, surrounding monitoring system 1A includes imaging apparatus 200 and imaging control apparatus 100A.

Imaging apparatus 200 is the same as imaging apparatus 200 described in Embodiment 1.

Imaging control apparatus 100A is, for example, an electronic control unit (ECU), and includes an input terminal, an output terminal, a processor, a program memory and a main memory mounted on a control substrate to control monitoring of the rear side of vehicle V.

The processor executes programs stored in the program memory by using the main memory to process various signals received via an input terminal, and transmit various control signals to light source 210 and image sensor 220 via the output terminal.

When the processor executes the program, imaging control apparatus 100A functions as first controller 11A and second controller 120A (an example of a “controller”) as shown in FIG. 10.

First controller 110A has the same function as that of controller 110 described in Embodiment 1.

Second controller 120A clusters a pixel corresponding to target T based on the infrared image signal outputted from image sensor 220. That is, second controller 120A has the same function as the function of clustering processor 120 in Embodiment 1. In other words, second controller 120A includes clustering processor 120.

Furthermore, second controller 120A derives distance dt (see FIG. 4) to target T in the imaging range by a TOF method based on the depth image signal outputted from image sensor 220. That is, second controller 120A has the same function as the function of distance measurer 130 in Embodiment 1. In other words, second controller 120A includes distance measurer 130.

Furthermore, second controller 120A estimates height ht of target T based on distance dt to target T.

Surrounding monitoring system 1A outputs a signal related to distance dt to above target T and a signal related to height ht of target T. This information is transmitted to, for example, advanced driver assistance system (ADAS) ECU 300A. ADAS ECU 300A automatically drives vehicle V by using these pieces of information.

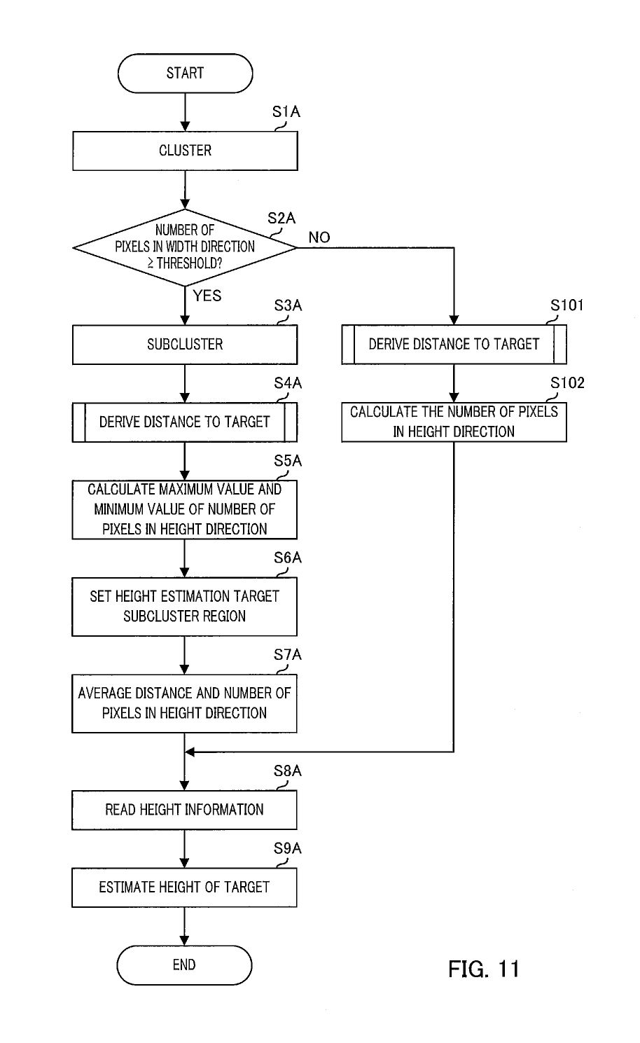

Next, height estimation processing performed by second controller 120A will be described in detail with reference to a flowchart in FIG. 11.

First, in step S1A, second controller 120A extracts feature points and clusters a plurality of pixels, and sets cluster regions based on the infrared image signal received from image sensor 220.

For example, second controller 120A extracts as feature points a plurality of pixels whose luminance in the imaging range is higher than a predetermined value and is within a predetermined range, and sets the plurality of pixels as cluster regions. Such a predetermined value and a predetermined range are determined in advance based on an experiment. In addition, such clustering is performed not only on neighboring pixels but also on dispersed pixels.

In subsequent step S2A, second controller 120A decides whether or not the number of pixels in a width direction of each cluster region is a predetermined threshold or more.

When it is decided in step S2A that the number of pixels in the width direction in each cluster region is not the threshold or more, processing proceeds to step S101. Processing performed in step S101 will be described below.

On the other hand, when it is decided in step S2A that the number of pixels in the width direction in each cluster region is the threshold or more, processing proceeds to step S3A.

In step S3A, second controller 120A divides and subclusters the cluster region in the width direction, and sets subcluster regions. For example, second controller 120A divides the cluster region into predetermined pixels (e.g., 10 pixels) in the width direction, and sets each pixel as the subcluster region. Furthermore, for example, second controller 120A divides the cluster region into n regions (n: natural number) in the width direction, and sets each region as the subcluster region.

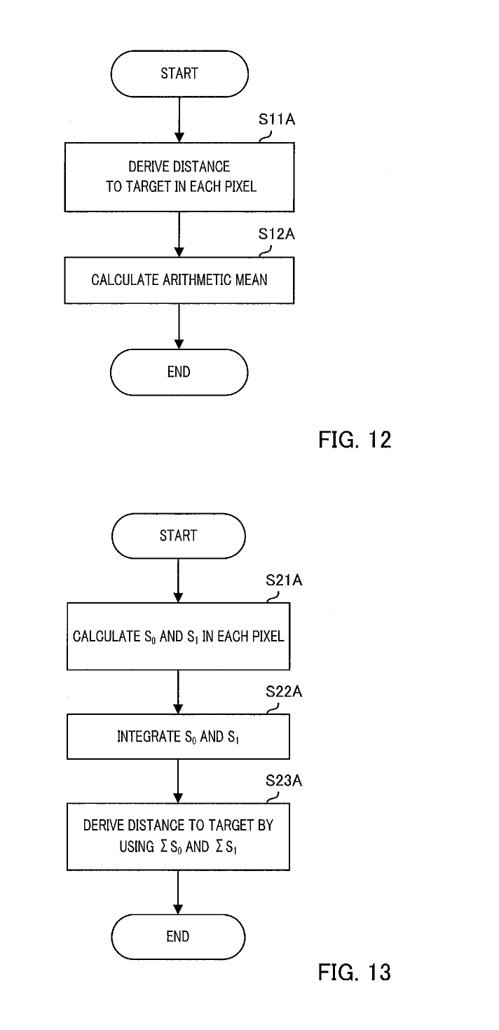

In subsequent step S4A, second controller 120A derives a distance to a target per subcluster region by using a depth image signal. An example of processing (distance measurement processing) which is performed per subcluster region in step S4A and derives a distance to a target will be described in detail with reference to a flowchart in FIG. 12.

First, in step S11A, second controller 120A derives the distance to the target in each pixel of each subcluster region by the TOF method.

In subsequent step S12A, second controller 120A calculates an arithmetic mean of the distances to the target in the respective pixels in the clustered regions, and calculates a representative distance to the target in each subcluster region. Furthermore, the calculated representative distance is outputted as the distance to the target in the subcluster region.

Another example of distance measurement processing performed per subcluster region in step S4A will be described in detail with reference to a flowchart in FIG. 13. In the above example, the distance to the target in each pixel in each subcluster region is calculated, then an arithmetic mean of the distances is calculated, and a distance to the subcluster region is calculated. By contrast with this, in the example described below, return light components of each pixel of each subcluster region are integrated, and a distance to the target in each subcluster is calculated by using the integrated return light components.

In step S21A, second controller 120A calculates return light components S₀ and S₁ in each pixel in each subcluster region by using the depth image signal according to above Equations 2 and 3.

In subsequent step S22A, second controller 120A integrates return light components S₀ and S₁ of each pixel in each subcluster region, and obtains integration values ΣS₀ and ΣS₁ of the return light components.

In subsequent step S23A, second controller 120 derives a representative distance to each subcluster region, i.e., distance dt to the target in each subcluster region by using the above Equation 5.

Back to description of FIG. 11, in step S5A subsequent to step S4A, second controller 120A calculates a maximum value and a minimum value of the number of pixels in a height direction of the target per subcluster region.

In subsequent step S6A, second controller 120A extracts subcluster regions whose distance to target is within a predetermined range and whose maximum value and minimum value of the number of pixels in the height direction are within a predetermined range, and sets the subcluster regions as height estimation target subcluster regions.

In subsequent step S7A, second controller 120A averages the distances to the target in the height estimation target subcluster regions, and the numbers of pixels in the height direction.

In subsequent step S8A, second controller 120A refers to a lookup table (LUT) stored in advance, and reads height information of each unit pixel corresponding to the distance to the target (height information of each unit pixel of predetermined pixels corresponding to the target). The height information of the unit pixel corresponding to the distance to the target changes according to an FOV (Field of View) in a vertical direction and an image size of imaging apparatus 200.

In subsequent step S9A, second controller 120A estimates and outputs the height of the target based on the number of pixels in the height direction of each pixel corresponding to the target and the height information of each unit pixel corresponding to the distance to the target (height of target)=(number of pixels in height direction of pixel corresponding to target)×(height information of each unit pixel corresponding to distance to target).

When “NO” is decided in step S2A, second controller 120A derives a distance to the target in each cluster region in step S101. Processing of deriving the distance to the target is the same as processing performed in above step S4A (more specifically, steps S11A and S12A or steps S21A or S23A), and therefore will not be described.

In subsequent step S102, second controller 120A calculates the number of pixels in the height direction of the target in each cluster region. More specifically, second controller 120A calculates an average value of the numbers of pixels in the height direction in the cluster regions. Subsequently, the processing proceeds to above step S8A.

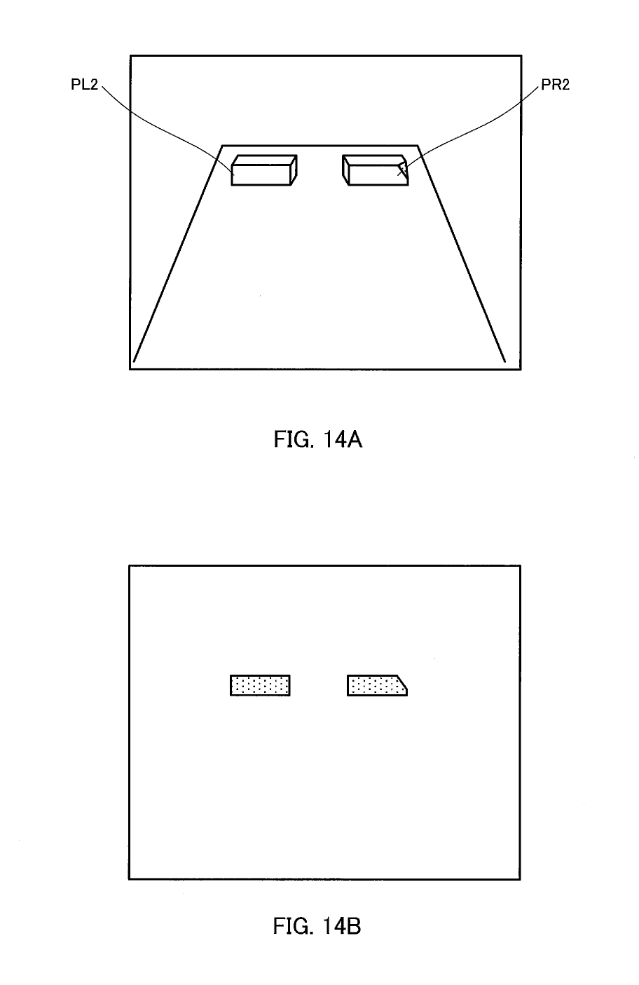

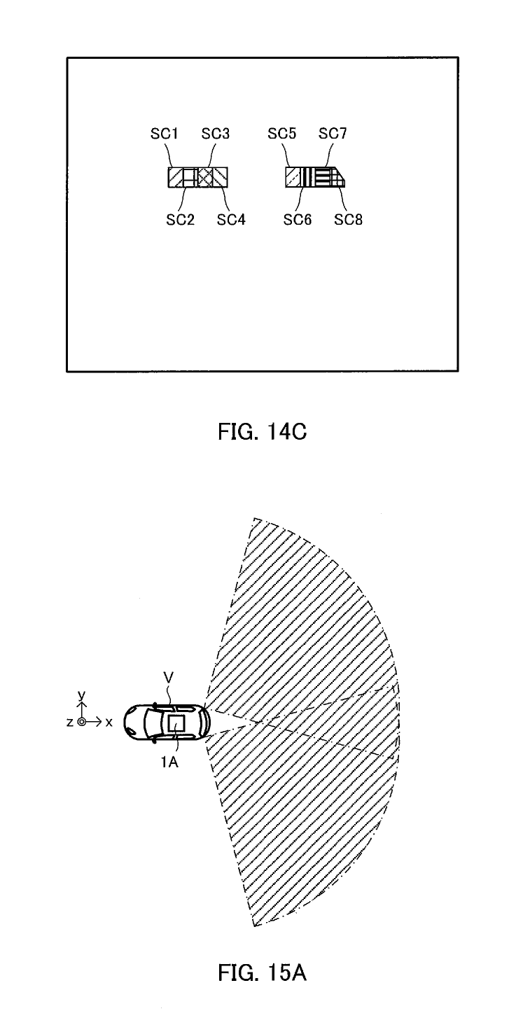

Next, a specific example of height estimation of a target performed by surrounding monitoring system 1A on which imaging control apparatus 100A according to Embodiment 2 is mounted will be described with reference to FIGS. 14A to 14C.

In the specific example described below, when subject vehicle V is parked by driving backward in a parking space provided with wheel stoppers PR2 and PL2, the heights of wheel stoppers PR2 and PL2 are estimated.

FIG. 14A shows a visible image of wheel stoppers PR2 and PL2 included in an imaging range. In this example, as shown in FIG. 14A, part of wheel stopper PR2 is defective. Furthermore, FIG. 14B shows an infrared image of wheel stoppers PR2 and PL2. In addition, the infrared image shown in FIG. 14B is obtained by using the above lattice transformation.

As shown in FIG. 14B, the infrared image shows pieces of high luminance of front end surfaces of wheel stoppers PR2 and PL2 facing image sensor 220. On the other hand, other portions such as a defective portion of wheel stopper PR2 and a road surface forming a large angle with respect to imaging apparatus 200 and having a low reflectance have low luminance. In addition, FIG. 14B shows only the front end surfaces of wheel stoppers PR2 and PL2 of high luminance for ease of understanding.

Positions in the forward and backward directions of the front end surfaces of wheel stoppers PR2 and PL2 are within the predetermined range. Therefore, the pieces of luminance of the front end surfaces of wheel stoppers PR2 and PL2 in the infrared image are within the predetermined range. Furthermore, the pieces of luminance of the front end surfaces of wheel stoppers PR2 and PL2 are a predetermined value or more. Hence, imaging control apparatus 100A (more specifically, second controller 120A) clusters the front end surfaces of wheel stoppers PR2 and PL2.

Subsequently, second controller 120A decides whether or not to subcluster cluster regions. In this example, the numbers of pixels in the width direction of the clustered front end surfaces of wheel stoppers PR2 and PL2 are a threshold or more. Hence, second controller 120A divides and subclusters the cluster region in the width direction. FIG. 14C shows an example where the front end surfaces of wheel stoppers PR2 and PL2 are divided into predetermined pixels in the width direction, and subcluster regions SC1, SC2, . . . and SC8 are set.

Subsequently, second controller 120A derives the distance to the target in each of subcluster regions SC1, SC2, . . . and SC8 by the TOF method.

Subsequently, second controller 120A sets height estimation target subcluster regions from subcluster regions. The distance to the target in each of the subcluster regions SC1, SC2, . . . and SC8 is within a predetermined range. On the other hand, while maximum value and minimum value of the numbers of pixels in the height direction of the subcluster regions SC1 and SC7 are within the predetermined range, a difference between a maximum value and a minimum value of the number of pixels in the height direction of the subcluster region SC8 is great, and the minimum value is not within the predetermined range. Hence, second controller 120A sets subcluster regions SC1, SC2, . . . and SC7 except subcluster region SC8 as the height estimation target subcluster regions.

Subsequently, second controller 120A averages the distances to the target in the height estimation target subcluster regions, and the numbers of pixels in the height direction. Furthermore, second controller 120A reads height information of each unit pixel corresponding to the distance to the target by using the LUT, and estimates the heights of the targets (wheel stoppers PR2 and PL2).

When, for example, the averaged distance is 10 meters, the FOV in a vertical direction is 155 degrees and an image size is 1920 pixels×1080 pixels, the pixels corresponding to the front end surfaces of wheel stoppers PR2 and PL2 include height information of approximately 2.5 centimeters per unit pixel. When the averaged number of pixels is four, the heights of the front end surfaces of wheel stoppers PR2 and PL2 are estimated as 10 centimeters.

In addition, when the maximum value and the minimum value of the number of pixels in the height direction of the target per subcluster region are calculated, as a result, there are subcluster regions whose maximum value of the number of pixels in the height direction is not within the predetermined range, the height of the target may be estimated based on the maximum value without setting the height estimation target subcluster regions.

By so doing, when a vehicle cannot substantially run over a target, for example, a thin structure such as a banner is attached to a target, it is possible to expect an effect of preventing a target from being erroneously recognized as a target which the vehicle can run over by averaging the numbers of pixels in the height direction.

As described above, according to Embodiment 2, feature points are extracted based on an infrared image, and regions from which the feature points are extracted are clustered. Furthermore, the distance to the target is calculated by using information of each pixel in each clustered region, and the height of the target is estimated by using the calculated distance to the target.

Consequently, it is possible to precisely estimate the height of the target.

In addition, above Embodiment 2 has been described as a specific example of detection of wheel stoppers in which feature points are extracted based on an infrared image and regions from which feature points are extracted are clustered, however it is not limited to this. For example, so-called edge extraction for extracting an edge of a target object by using a luminance difference based on an infrared image may be performed, and a range from which the edge is extracted may be clustered.

Furthermore, for example, an edge of the target object may be extracted by using distance information based on a distance image. Furthermore, for example, the edge of the target object may be extracted based on a visible image obtained by an imaging apparatus which can obtain a visible image. Furthermore, an infrared image, a distance image and a visible image may be used in combination to extract the edge.

Above Embodiment 2 has been described in which feature points are extracted based on an infrared image, however it is not limited to this. For example, feature points may be extracted based on a distance image. An example where feature points are extracted based on the distance image will be describe below.

When the present disclosure is used to detect the heights of wheel stoppers, while front end surfaces of the wheel stoppers face the imaging apparatus, an angle between the imaging apparatus and a road surface on which the wheel stoppers are installed is great. Hence, a reflection intensity of the road surface is remarkably lower than a reflection intensity of the front end surfaces of the wheel stoppers.

By using this, controller 110A controls an output or the number of shots of the light source such that only distance information of the wheel stoppers in a region (e.g., a range of 5 meters to 15 meters) in which the wheel stoppers need to be detected can be detected (in other words, distance information other than the wheel stoppers is not detected).

By so doing, second controller 120A can extract feature points by using the distance image without using the infrared image.

In above Embodiment 2, a lower limit threshold of a luminance to be clustered is fixed, however it is not limited to this. For example, the predetermined range may be changed according to conditions. An example where the predetermined range is changed will be described below.

When the present disclosure is used to detect the heights of the wheel stoppers, various types of a road surface on which the wheel stoppers are installed are assumed to include concrete, asphalt, bricks, gravels, grasses and mud. Imaging control apparatus 100 stores a reflectance of each type of these road surfaces in a memory.

Furthermore, second controller 120A changes the predetermined range of the luminance to be clustered according to the reflectance of the road surface. When, for example, comparison is made between the mud road surface and the concrete road surface, a reflectance of the mud<<a reflectance of the concrete holds. That is, a difference from the luminance of the wheel stoppers to be clustered is remarkably great in a case of the mud than in the case of the concrete.

Hence, when the reflectance of the road surface is low, even if the range of the luminance to be clustered is widened, pixels corresponding to the road surface are less likely to be clustered by mistake. Therefore, second controller 120A widens the range of the luminance to be clustered. By so doing, even when a variation of the reflectances of the front end surfaces of the wheel stoppers is great, it is possible to cluster an appropriate range.

In above Embodiment 2, the imaging apparatus (more specifically, the image sensor) outputs the distance to the target, however it is not limited to this. For example, when a distance from a position of a vehicle to a target is outputted, the position can be changed according to the height of the target. Specific description is as follows.

Second controller 120A estimates the height of the target, and decides whether or not the target is wheel stoppers or a wall according to the estimated height.

When it is decided that the target is the wheel stoppers, second controller 120A outputs the distance over which wheels of the vehicle travel to touch the wheel stoppers by using diameters of the wheels or the heights of the wheel stoppers. On the other hand, when the target is not the wheel stoppers but the wall, a distance from both end portions of the vehicle (a front end portion or a rear end portion) to the wall is outputted.

By so doing, the vehicle can be automatically driven to move the vehicle to an appropriate position according to surrounding environment.

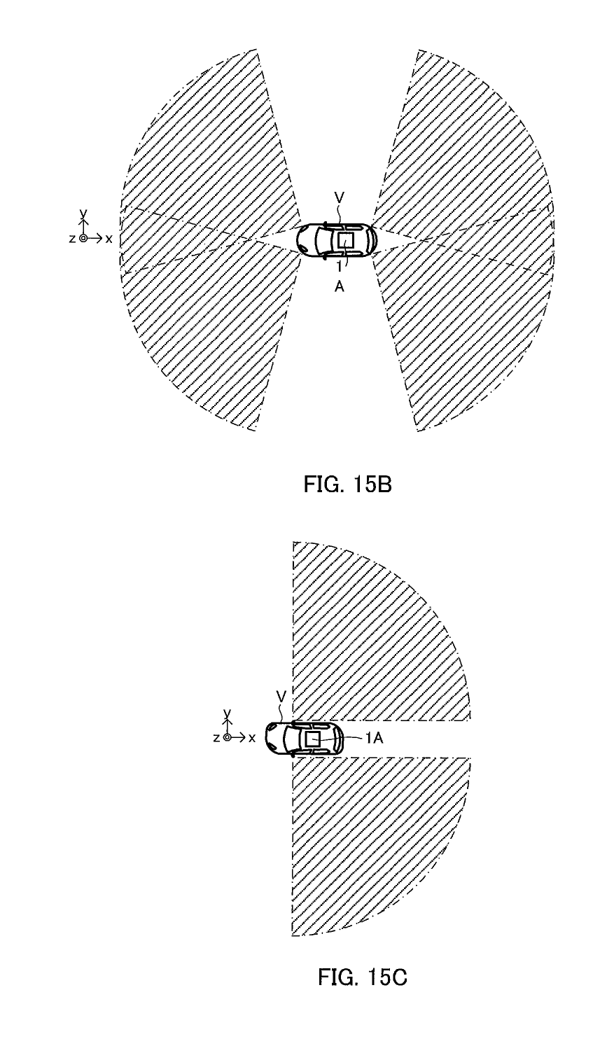

Above Embodiment 2 has been described in a case where imaging apparatus 200 is attached to a back surface of the vehicle, however it is not limited to this. Even when an imaging apparatus installed for use in monitoring surroundings of the vehicle is used as shown in FIGS. 15A to 15C, it is possible to precisely estimate the height of the detected target similar to the above embodiments.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2017-168597, filed on Sep. 1, 2017, and Japanese Patent Application No. 2017-168600, filed on Sep. 1, 2017, the disclosures of which including the specifications, drawings and abstracts are incorporated herein by reference in their entirety.

### INDUSTRIAL APPLICABILITY

The imaging control apparatus, the imaging control method, the imaging control program and the recording medium having the imaging control program recorded thereon according to the present disclosure can improve distance measurement precision of a time of flight distance measurement method. Furthermore, the imaging control apparatus, the imaging control method, the imaging control program and the recording medium having the imaging control program recorded thereon can improve height measurement precision of a target. Consequently, the imaging control apparatus, the imaging control method, the imaging control program and the recording medium having the imaging control program recorded thereon are suitable for use in vehicles.

### REFERENCE SIGNS LIST

1, 1A Surrounding monitoring system
100, 100A Imaging control apparatus
110 Controller
110A First controller
120 Clustering processor
120A Second controller
130 Distance measurer
140 Edge extractor
150 Target extractor
200 Imaging apparatus
210 Light source
220 Image sensor
300, 300A ADAS ECU

1. An imaging control apparatus comprising:
a clustering processor which clusters a region from which a feature point is extracted based on an infrared image or a distance image obtained by an imaging apparatus; and
a distance measurer which derives a distance to a target corresponding to the region by a time of flight distance measurement method based on information of each pixel in the region clustered by the clustering processor.

2. The imaging control apparatus according to claim 1, wherein the distance measurer
derives a distance to a target corresponding to each pixel of the clustered region by a time of flight distance measurement method, and
calculates the distance to the target corresponding to the region by calculating an arithmetic mean of the derived distance to the target corresponding to each pixel.

3. The imaging control apparatus according to claim 1, wherein the distance measurer
integrates a return light component of each pixel of the clustered region, and
derives the distance to the target corresponding to the region by the time of flight distance measurement method based on an integration value of the return light component.

4. The imaging control apparatus according to claim 1, further comprising a controller which estimates a height of the target based on the distance to the target derived by the distance measurer.

5. The imaging control apparatus according to claim 4, wherein the controller
divides the region in a width direction and sets a subcluster region when a number of pixels in a width direction in the region is a threshold or more, and
estimates the height of the target based on the distance to the target derived per subcluster region.

6. An imaging control method comprising:
clustering a region from which a feature point is extracted based on an infrared image or a distance image obtained by an imaging apparatus; and
deriving a distance to a target corresponding to the region by a time of flight distance measurement method based on information of each pixel in the clustered region.

7. An imaging control program causing a computer to execute:
clustering a region from which a feature point is extracted based on an infrared image obtained by an imaging apparatus; and
deriving a distance to a target corresponding to the region by a time of flight distance measurement method based on information of each pixel in the clustered region.

8. A recording medium having the imaging control program according to claim 7 recorded thereon.
